(19) United States
(12) Patent Application Publication
(10) Pub. No.: US 2011/0320688 A1
(43) Pub. Date: Dec. 29, 2011

(54) Memory Systems And Wear Leveling Methods

(75) Inventor: Yangsup Lee, Hwaseong-si (KR)

(73) Assignee: SAMSUNG ELECTRONICS CO., LTD., Suwon-si (KR)

(21) Appl. No.: 13/093,376

(22) Filed: Apr. 25, 2011

(30) Foreign Application Priority Data
Jun. 29, 2010 (KR) 10-2010-0062161

(51) Int. Cl. G06F 12/02

(52) U.S. Cl. 711/103; 711/E12.008

(57) ABSTRACT

Wear leveling methods in memory systems with nonvolatile memory devices including a plurality of physical blocks and memory controllers controlling the nonvolatile memory devices. The wear leveling method increases a stress index of the physical blocks according to operations the physical blocks have undergone and performs wear leveling of the physical block on the basis of the stress index.

### CROSS-REFERENCE TO RELATED APPLICATION

This U.S. non-provisional patent application claims priority under 35 U.S.C. §119 to Korean Patent Application No. 10-2010-0062161, filed on Jun. 29, 2010, in the Korean Intellectual Property Office (KIPO), the entire contents of which is hereby incorporated by reference.

### BACKGROUND

Example embodiments of the inventive concepts relate to memory systems and a wear leveling methods thereof.

Generally, a semiconductor memory device is a micro electronic device used in digital logic designs such as microprocessor-based applications and computers ranging from satellites to consumer electronic technologies. The advance of semiconductor memory manufacturing technologies including by process enhancement and technology development obtained through scaling for high integration density and high speed may establish performance standards for different digital logic series.

Semiconductor memory devices are broadly categorized into volatile and nonvolatile semiconductor memory devices. Nonvolatile semiconductor memory devices may store data even when power is shut off. Data stored in nonvolatile memories may be permanent or reprogrammable depending on the memory manufacturing technology. Nonvolatile semiconductor memory devices are used for storing programs and micro codes in a wide range of applications for technical industries such as computers, avionics, communications, and consumer electronics.

A flash memory device is a representative example of a nonvolatile memory device. Flash memory may include multi-bit memory devices that store multi bits in one memory cell.

### SUMMARY

Example embodiments of the inventive concepts may provide memory systems and wear leveling methods thereof, which may perform increased accuracy wear leveling. Example embodiments of the inventive concepts may also provide memory systems and wear leveling methods thereof, which perform wear leveling without using erasure count.

According to example embodiments of the inventive concepts a wear leveling method in a memory system includes a nonvolatile memory device including a plurality of physical blocks and a memory controller controlling the nonvolatile memory device, including increasing a stress index of one physical block of the plurality of physical blocks according to an operation which the physical blocks has undergone and performing wear leveling of the physical block on the basis of the stress index.

According to some example embodiments of the inventive concepts, the stress index may increase according to an erasing operation or a programming operation which the physical block has undergone. According to other example embodiments of the inventive concepts, the stress index may increase according to a reading operation which the physical block has undergone. According to still other example embodiments of the inventive concepts, the stress index may vary according to a temperature or noise of the memory system. According to even other example embodiments of the inventive concepts, the stress index may have a constant increase amount upon the erasing operation and have a constant increase amount upon the programming operation.

According to yet other example embodiments of the inventive concepts, the stress index may increase by 25 upon the erasing operation and increase by 1.17 upon the programming operation. According to further example embodiments of the inventive concepts, an increase amount of the stress index upon the erasing operation may differ from an increase amount of the stress index upon the programming operation. According to still further example embodiments of the inventive concepts a block information table, including the physical block and the stress index which corresponds to the physical block, may be stored in the nonvolatile memory device. According to even further example embodiments of the inventive concepts, the performing of wear leveling may copy data, which is stored in a physical block having a maximum stress index, in a physical block having a minimum stress index when a difference between the maximum stress index and the minimum stress index is greater than a predetermined value, upon a writing request.

According to yet further example embodiments of the inventive concepts, the performing of wear leveling may include determining whether a free page exists, erasing a data block when the free page does not exist, copying the data of the physical block having the maximum stress index in the erased data block when the difference between the maximum stress index and the minimum stress index is greater than the predetermined value, erasing the physical block having the maximum stress index, copying data of the physical block having the minimum stress index in the physical block having the maximum stress index, erasing the physical block having the minimum stress index, and writing data in the erased physical block having the minimum stress index. According to much further example embodiments of the inventive concepts, the performing of wear leveling may include determining whether a free page exists, erasing a data block when the free page does not exist, and writing data in the erased data block when the difference between the maximum stress index and the minimum stress index is not greater than the predetermined value.

According to still much further example embodiments of the inventive concepts, the performing of wear leveling may copy data of a physical block, which exceeds a read refresh time corresponding to a stress index, in a physical block having a minimum stress index upon a read request. According to even much further example embodiments of the inventive concepts, as the stress index increases, the read refresh time may decrease. According to other example embodiments of the inventive concepts, a memory system includes: a nonvolatile memory device storing a block information table which includes a number indicating a physical block and stress indexes corresponding to operations which the physical block has undergone; and a memory controller controlling the nonvolatile memory device, and performing wear leveling on the basis of the block information table.

According to some example embodiments of the inventive concepts, the block information table may further include erasure count of the physical block. According to other example embodiments of the inventive concepts, the block information table may further include programming count of the physical block. According to still other example embodiments of the inventive concepts, the block information table may further include read count of the physical block. According to even other example embodiments of the inventive concepts, the nonvolatile memory device may include a vertical memory cell array.

According to still other example embodiments of the inventive concepts, a memory system includes a nonvolatile memory device storing a block information table which includes a number indicating a physical block, erasure count of the physical block and programming count of the physical block, and a memory controller controlling the nonvolatile memory device, calculating a stress index of the physical block with the erasure count and the programming count, and performing wear leveling on the basis of the calculated stress index.

According to even other example embodiments of the inventive concepts, a memory system includes a nonvolatile memory device storing a block information table which includes a number indicating a physical block, erasure count of the physical block, programming count of the physical block and read count of the physical block and a memory controller controlling the nonvolatile memory device, calculating a stress index of the physical block with the erasure count, the programming count and the read count, and performing wear leveling on the basis of the calculated stress index.

According to further example embodiments, a wear leveling method includes increasing a stress index of one of a plurality of physical blocks in a memory system according to at least one operation performed on the physical block and wear leveling the memory system based on the stress index. According to still further example embodiments, a memory system includes a nonvolatile memory device configured to store a block information table including a number representing a physical block and a stress index representing a wear level of the physical block and a memory controller configured to control the nonvolatile memory device, and to perform wear leveling based on the block information table.

According to yet still further example embodiments, a memory system includes a nonvolatile memory device configured to store a block information table including a number representing a physical block, an erasure count of the physical block and a programming count of the physical block and a memory controller configured to control the nonvolatile memory device, to calculate a stress index of the physical block based on the erasure count and the programming count, and to perform wear leveling on the basis of the calculated stress index. According to yet still further example embodiments, a memory system includes a nonvolatile memory device configured to store a block information table including an erasure count of a physical block, a programming count of the physical block, a read count of the physical block and a number representing the physical block and a memory controller configured to control the nonvolatile memory device, to calculate a stress index of the physical block based on the erasure count, the programming count and the read count, and to perform wear leveling based on the calculated stress index.

According to still yet further example embodiments, a method of wear leveling a semiconductor device includes determining a usage level of each of a plurality of cells in a semiconductor device based on at least one operation of the plurality of cells, storing data corresponding to the usage levels and using the plurality of cells based on the usage levels.

### BRIEF DESCRIPTION OF THE DRAWINGS

Example embodiments will be more clearly understood from the following brief description taken in conjunction with the accompanying drawings. FIGS. 1-23 represent non-limiting, example embodiments as described herein.

FIG. 1 is a block diagram illustrating memory systems according to example embodiments of the inventive concepts;

FIG. 2 is a circuit diagram illustrating a physical block of FIG. 1;

FIG. 3 is a circuit diagram illustrating physical block stress in a programming operation;

FIG. 4 is a circuit diagram illustrating physical block stress in a reading operation;

FIG. 5 is a table illustrating a relationship of a stress index based on the number of programming operations on a physical block;

FIG. 6 is a block diagram illustrating stress index increase methods of a wear leveling module in FIG. 1 according to example embodiments of the inventive concepts;

FIG. 7 is a block diagram illustrating wear leveling methods using a stress index according to example embodiments of the inventive concepts;

FIG. 8 is a flowchart illustrating wear leveling methods of a memory system upon a write request;

FIG. 9 is a block diagram illustrating stress index increase methods of the wear leveling module in FIG. 1 according to other example embodiments of the inventive concepts;

FIG. 10 is a graph of read refresh time as a function of stress index according to example embodiments of the inventive concepts;

FIG. 11 is a flowchart illustrating wear leveling methods of the memory system upon a write request;

FIGS. 12A-12C are block diagrams illustrating block information tables according to example embodiments of the inventive concepts;

FIG. 13 is a block diagram illustrating memory systems according to other example embodiments of the inventive concepts;

FIG. 14 is a block diagram illustrating memory systems according to still other example embodiments of the inventive concepts;

FIG. 15 is a block diagram illustrating vertical NAND flash memory devices according to example embodiments of the inventive concepts;

FIG. 16 is a circuit diagram illustrating an equivalent circuit of one of the memory blocks in FIG. 15;

FIG. 17 is a block diagram illustrating memory systems according to example embodiments of the inventive concepts;

FIG. 18 is a block diagram illustrating memory cards according to example embodiments of the inventive concepts;

FIG. 19 is a block diagram illustrating a moviNAND according to example embodiments of the inventive concepts;

FIG. 20 is a block diagram illustrating Solid State Drives (SSDs) according to example embodiments of the inventive concepts;

FIG. 21 is a block diagram illustrating computing systems including the SSDs of FIG. 20 according to example embodiments of the inventive concepts;

FIG. 22 is a block diagram illustrating electronic devices including the SSDs of FIG. 20 according to example embodiments of the inventive concepts; and

FIG. 23 is a block diagram illustrating server systems using the SSDs of FIG. 20 according to example embodiments of the inventive concepts.

It should be noted that these figures are intended to illustrate the general characteristics of methods, structure and/or materials utilized in certain example embodiments of the inventive concepts and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will, be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc, may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments of the inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments of the inventive concepts.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Nonvolatile memory devices and memory systems including memory controllers controlling the same, according to example embodiments of the inventive concepts, may increase a stress index in proportion to operations that a physical block has undergone and perform wear leveling on the basis of the stress index, thereby performing improved wear leveling. Herein, wear leveling may be understood as maintaining constant wear levels of physical blocks configuring nonvolatile memory devices.

Nonvolatile memory devices according to example embodiments of the inventive concept may be NAND flash memory, vertical NAND flash memory, NOR flash memory, Resistive Random Access Memory (RRAM), Phase-change Random Access Memory (PRAM), Magnetoresistive Random Access Memory (MRAM) and/or Ferroelectric Random Access Memory (FRAM). Nonvolatile memory devices according to example embodiments of the inventive concepts may be implemented in a Three-Dimensional (3D) array structure. The inventive concept may be applied to, for example, flash memory devices where charge storage layers are configured as conductive floating gates and Charge Trap Flash (CTF) where charge storage layers are configured as an insulation layer.

Hereinafter, for convenience, nonvolatile memory devices according to embodiments of the inventive concept may be described with respect to NAND flash memory. Example embodiments are not so limited and other types of memory are contemplated. When nonvolatile memory devices according to example embodiments of the inventive concepts are NAND flash memory, operations that physical blocks according to example embodiments of the inventive concepts undergo may be one of an erasing operation, a programming operation and/or a reading operation.

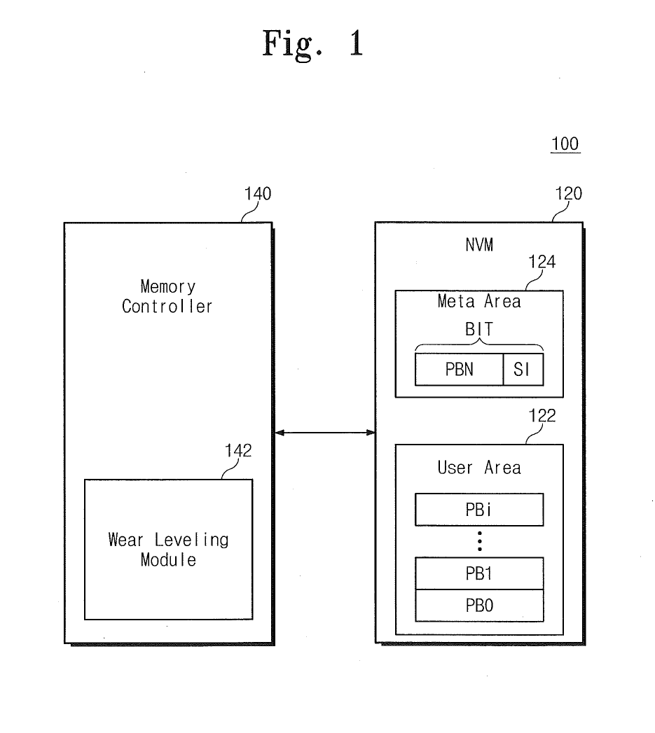

FIG. 1 is a block diagram illustrating memory systems according to example embodiments of the inventive concepts. Referring to FIG. 1, a memory system 100 according to example embodiments of the inventive concepts may include a nonvolatile memory device 120 and a memory controller 140. The nonvolatile memory device 120 may include a user area 122 for storing data and a meta area 124 for storing data. The user area 122 may store user data. The user area 122 may include a plurality of physical blocks PB0 to PBi, where i may be any natural number greater than 0. Each of the physical blocks PB0 to PBi may include a plurality of physical pages. The physical page may denote a set of memory cells connected to one word line. A single bit data and/or a multi-bit data may be stored in one memory cell. A memory cell for storing single bit data may be called a Single Level Cell (SLC) and a memory cell for multi-bit data may be called a Multi-Level Cell (MLC).

The meta area 124 may store control data for managing the nonvolatile memory device 120. The control data may include a Block Information Table (BIT) used for performing wear leveling. The block information table may include a Physical Block Number (PBN) corresponding to a physical block of the user area 122 and a Stress Index (SI) of a physical block indicated by the physical block number. According to example embodiments of the inventive concepts, the meta area 124 may include at least one physical block configured with a plurality of physical pages. According to example embodiments of the inventive concepts, the block information table may be included in a mapping table. The mapping table may store information on a physical block corresponding to a logical block.

The memory controller 140 may control the overall operation of the nonvolatile memory device 120. The memory controller 140 may include a wear leveling module 142 for performing wear leveling. The wear leveling module 142 may determine whether to satisfy at least one wear leveling condition upon a request for the operation of the nonvolatile memory device 120, and when the at least one wear leveling condition is satisfied, wear leveling is performed. The wear leveling condition may be determined on the basis of the stress index. For example, when the stress index is greater than a threshold value or a difference between the maximum stress index and the minimum stress index is greater than a threshold value, wear leveling may be performed.

The stress index may increase in proportion to an erasing operation, a programming operation and/or a reading operation that a physical block has undergone. The stress index may vary according to the temperature and/or noise of the memory system 100. According to example embodiments of the inventive concepts, the increased amount of the stress index may be constant for an erasing operation and a programming operation. For example, the stress index may increase by 25 in the erasing operation and the stress index may increase by 1.17 in the programming operation.

According to example embodiments of the inventive concepts, the increase amount of the stress index in the erasing operation may differ from the increase amount of the stress index in the erasing operation, according to a process condition of the nonvolatile memory device 120. For example, a stress index may increase by 25 in an erasing operation and may increase by 1.17 in a programming operation, in any one chip, but a stress index may increase by 24 in an erasing operation and may increase by 1 in a programming operation, in another chip. The wear leveling module 142 may be implemented with a firmware. For example, the wear leveling module 142 may include a Flash Translation Layer (FTL). The flash translation layer may be system software that manages erasing, programming and/or reading operations for using a nonvolatile memory device 120, for example, a hard disk. The flash translation layer may include mapping information management, bad block management, data retention management in the unexpected shutoff of a power source, and/or wear level management. According to other example embodiments of the inventive concepts, the wear leveling module 142 may be implemented in hardware. The memory system 100 may perform wear leveling on the basis of a stress index corresponding to an operation that a physical block has undergone, thereby performing more accurate and/or improved wear leveling.

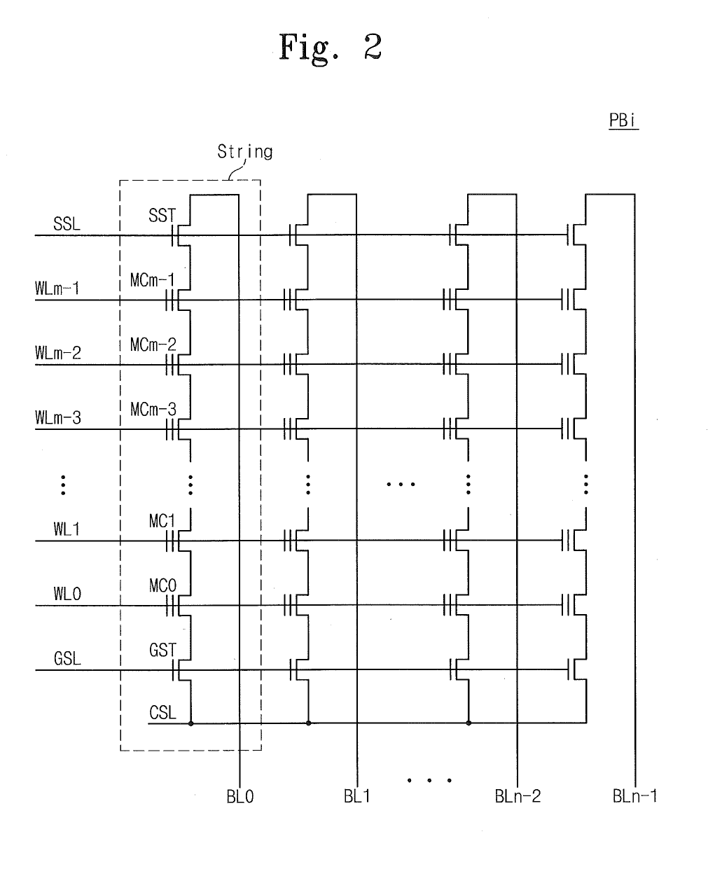

FIG. 2 is a circuit diagram illustrating a physical block of FIG. 1. Referring to FIG. 2, the physical block PBi may include a plurality of memory cells that are arranged in intersection regions between a plurality of word lines WL0 to WL(m−1) and a plurality of bit lines BL0 to BL(n−1), where m may be a natural number and n may be a natural number. The physical block PBi may include a plurality of strings connected to the bit lines BL0 to BL(n−1). Each string may include a string selection transistor SST connected to a string selection line SSL, a plurality of memory cells MC0 to MC(m−1) respectively connected to the word lines WL0 to WL(m−1), and a ground selection transistor GST connected to a ground selection line GSL. The string selection transistor SST may be connected to a bit line BL and the ground selection transistor GST may be connected to a common source line CSL. The common source line CSL may receive a ground voltage and/or a CSL voltage (e.g., VDD) from a CSL driver (not shown).

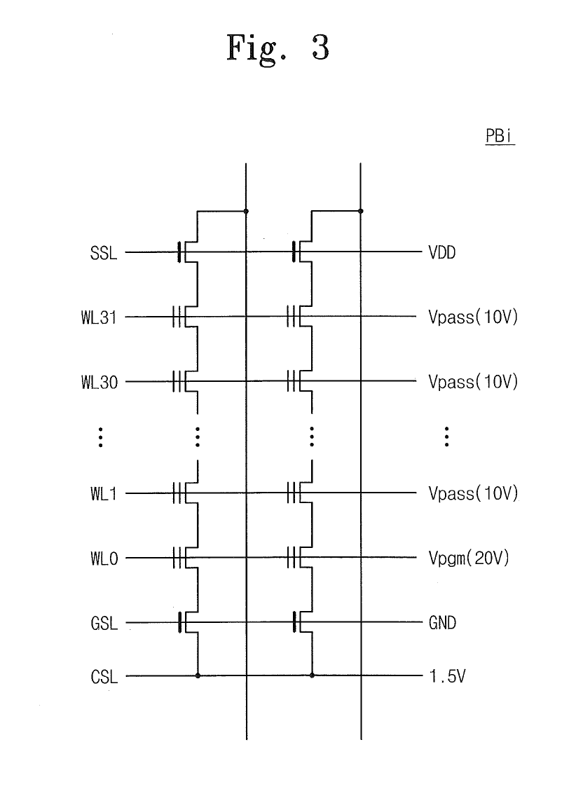

FIG. 3 is a circuit diagram illustrating physical block stress in a programming operation. Referring to FIG. 3, when a programming operation is performed in a page corresponding to a word line WL0, a program voltage Vpgm may be applied to a selected word line WL0 and a pass voltage Vpass may be applied to unselected word lines WL1-WL31. The program voltage Vpgm may be, for example, 20V, and the pass voltage Vpass may be, for example, 10 V. When a programming operation is performed in all the pages of the physical block PBi, each of the pages may undergo a one-time program voltage Vpgm and a 64-time (as another example, 32-time) pass voltage Vpass. The common source line CSL voltage may be, for example, 1.5V. Because the pass voltage Vpass may be 10 V, unselected memory cells may undergo a considerably large or increased stress. A reason that the physical block PBi may undergo the 64-time pass voltage Vpass is because memory cells respectively connected to the word lines WL0-WL31 may undergo an odd page programming operation and an even page programming operation.

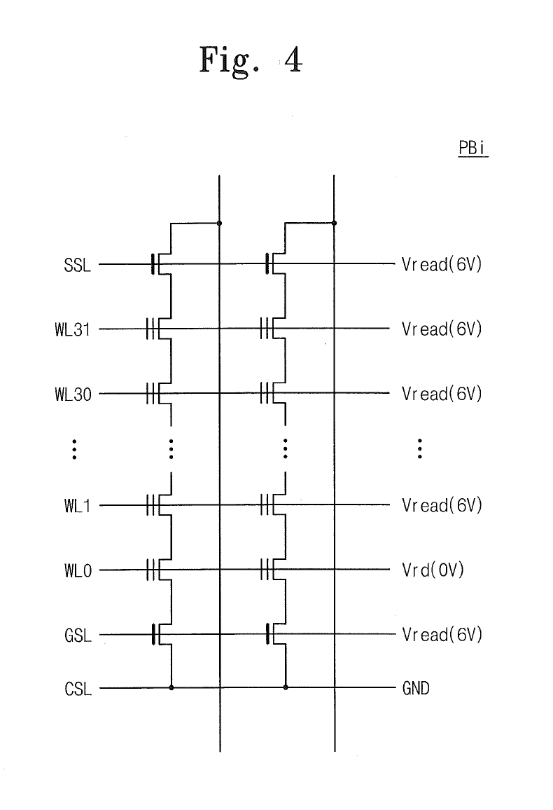

FIG. 4 is a circuit diagram illustrating physical block stress in a reading operation. Referring to FIG. 4, when a reading operation is performed in a page corresponding to a word line WL0, a selection read voltage Vrd may be applied to a selected word line WL0 and a non-selection read voltage Vread may be applied to unselected word lines WL1-WL31. The selection read voltage Vrd may be, for example, 0 V, and the non-selection read voltage Vread may be, for example, 6 V. A non-selection read voltage Vread of 6 V may cause a read disturbance. Read disturbance may denote that a memory cell is programmed with the non-selection read voltage Vread. The non-selection read voltage Vread may slightly affect the service life of the nonvolatile memory device 120.

As described above with reference to FIGS. 3 and 4, the programming operation and the reading operation may affect the service life of the nonvolatile memory device 120. For accurately managing the wear level of the nonvolatile memory device 120, the erase, program and/or read operations may be required to be used in managing a wear level. The following Table 1 may show wear levels by a programming operation in a physical block.

TABLE 1

| TYPE | WEAR-OUT LEVEL |
|---|---|
| ERASE & ALL PAGE PROGRAM | 100% |
| ERASE & SOME PAGE PROGRAM | . . . |
| ERASE ONLY | 20~30% |

For convenience, it may be assumed that a wear level is 100% when all pages are programmed and the wear level is 20˜30% when only an erasing operation is performed. Referring to Table 1, when measuring a degree of stress while changing the number of pages for performing the programming operation of the physical block PBi from 1 to 64, a stress index may increase by 25 in the erasing operation and by 1.17 in the programming operation.

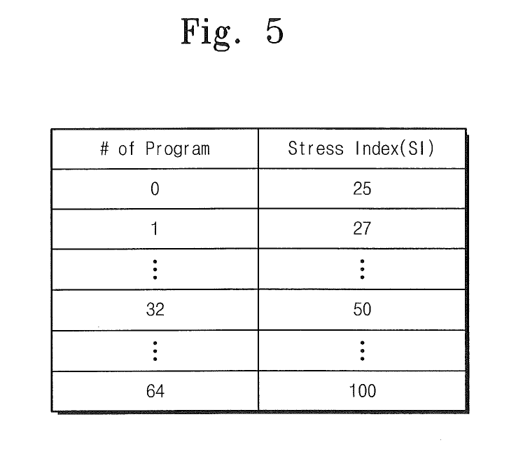

FIG. 5 is a table illustrating a relationship of a stress index based on the number of programming operations on a physical block. Referring to FIG. 5, when a programming operation is never performed (e.g., when only an erasing operation is performed) a stress index may be 25. A stress index may be 27 when the programming operation is performed once, the stress index may be 50 when the programming operation is performed 32 times, and the stress index may be 100 when the programming operation is performed 64 times. The stress index of the physical block PBi may increase in proportion to the number of programming operations.

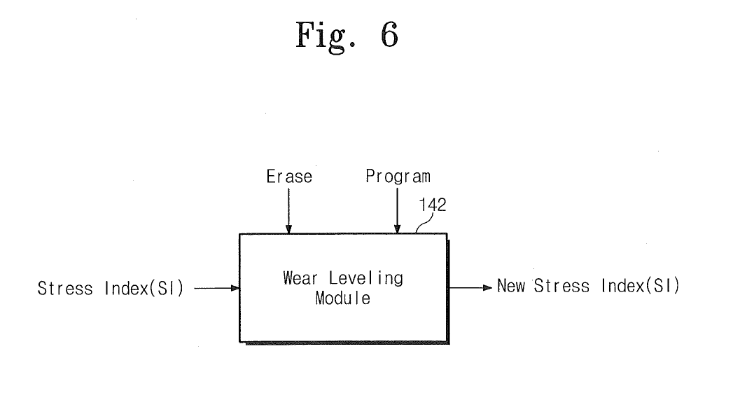

FIG. 6 is a block diagram illustrating stress index increase methods of a wear leveling module in FIG. 1 according to example embodiments of the inventive concepts. Referring to FIG. 6, the wear leveling module 142 may increase a stress index according to an erasing operation and/or a programming operation. For example, when an erasing operation is performed in the physical block PBi, the wear leveling module 142 may output a new stress index that may be obtained by increasing an input stress index by 25. When the programming operation is performed in the physical block PBi, the wear leveling module 142 may output a new stress index that may be obtained by increasing the input stress index by 1.17.

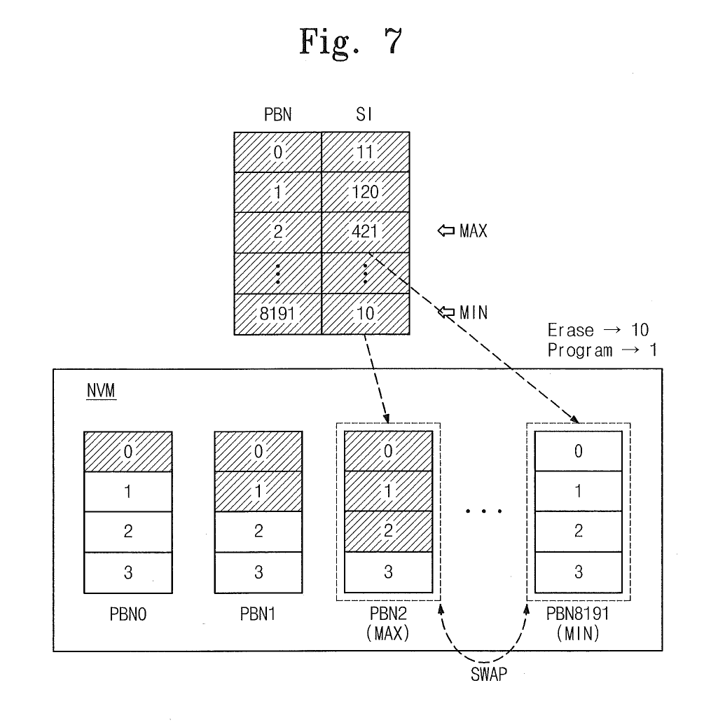

FIG. 7 is a block diagram illustrating wear leveling methods using a stress index according to example embodiments of the inventive concepts. For convenience, it may be assumed that a stress index increases by 10 when an erasing operation is performed and the stress index increases by 1 when a programming operation is performed. It may be assumed that each physical block includes four pages. These assumptions are for purposes of explanation only and not for limitation of example embodiments. Referring to FIG. 7, a first physical block PBN0 may have a stress index of 11 in the block information table. This may denote that the first physical block PBN0 undergoes a one-time erasing operation and a one-time programming operation.

A physical block PBN2 may have the maximum stress index value MAX and a physical block PBN8191 may have the minimum stress index value MN. A wear leveling condition according to example embodiments of the inventive concepts may be a difference between the maximum stress index value MAX and the minimum stress index value MIN. That is, when the difference between the maximum stress index value MAX and the minimum stress index value MIN is greater than a predetermined value in the block information table, wear leveling is performed.

For example, the maximum stress index value MAX may be 421 and the minimum stress index value MIN may be 10. It may be assumed that a threshold value is 410, the difference between the maximum stress index value MAX and the minimum stress index value MIN is greater than the threshold value. The physical block PBN2 corresponding to the maximum stress index value MAX and the physical block PBN8191 corresponding to the minimum stress index value MIN may be exchanged through wear leveling. Exchange may denote that data of the physical block PBN2 having the maximum stress index value MAX and data of the physical block PBN8191 having the minimum stress index value MN may be exchanged.

According to example embodiments of the inventive concepts, when the difference between the maximum stress index value MAX and the minimum stress index value MN is greater than the threshold value, the physical block PBN8191 having the smallest stress index value and the physical block PBN2 having the largest stress index value are exchanged, and thus wear leveling may be performed.

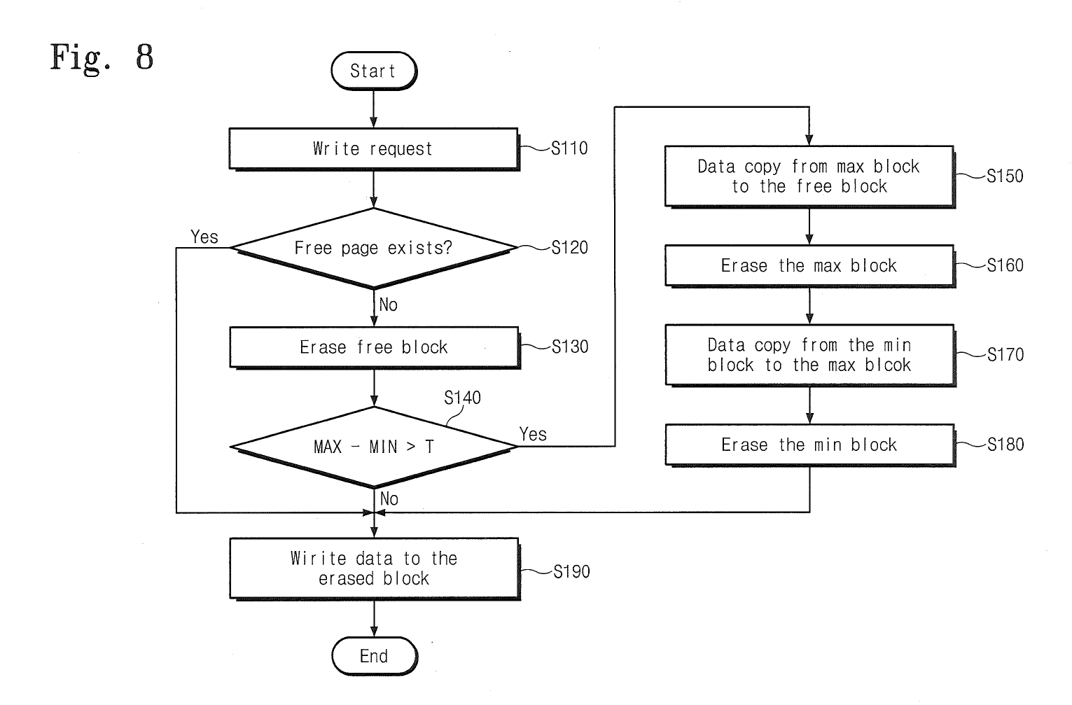

FIG. 8 is a flowchart illustrating wear leveling methods of a memory system 100 upon a writing request. Referring to FIGS. 1-8, a host may request a write to the memory system 100. The memory controller 140 (see FIG. 1) may receive a writing command, data to be written and a logical address, based on the writing request in operation S110. The writing request may be input from the host to the memory controller 140. The data to be written and the logical address may be input together in operation S110. The memory controller 140 may determine whether a free page for writing data exists in operation S120. When the free page exists, operation S190 may be performed and data may be written to the erased block. When the free page does not exist, the memory controller 140 may erase the free block of the nonvolatile memory device 120. The free block may be one of the physical blocks PB0-PBi included in the user area 122.

The wear leveling module 142 (see FIG. 1) may determine whether a difference between the maximum stress index value MAX and the minimum stress index value MIN is greater than a threshold value T on the basis of the block information table in operation S140. When the difference between the maximum stress index value MAX and the minimum stress index value MIN is not greater than the threshold value T, operation S190 may be performed. When the difference between the maximum stress index value MAX and the minimum stress index value MIN is greater than the threshold value T, data of the physical block PBN2 (see FIG. 7) corresponding to the maximum stress index value MAX may be copied in an erased free block in operation S150. The physical block PBN2 corresponding to the maximum stress index value MAX may be erased in operation S160.

Data of the physical block PBN8191 (see FIG. 7) corresponding to the minimum stress index value MIN may be copied into the erased physical block PBN2 corresponding to the maximum stress index value MAX in operation S170. The physical block PBN8191 corresponding to the minimum stress index value MIN may be erased in operation S180. The physical block PBN8191 having the minimum stress index value MIN may become a new free block. Data to be written may be written in an erased block in operation S190. The erased block may be one of the existing free blocks, an erased free block and a new free block. According to example embodiments of the inventive concepts, a physical block having the minimum stress index value may be exchanged with a new free block when a wear leveling condition is satisfied upon a writing request.

A difference between the maximum stress index value MAX and the minimum stress index value MIN may be used as a wear leveling condition. However, example embodiments of the inventive concepts are not limited thereto. The wear leveling method according to example embodiments of the inventive concepts may use, for example, the maximum stress index value MAX as the wear leveling condition. For example, wear leveling may be performed when the maximum stress index value MAX is greater than a threshold value upon a write request.

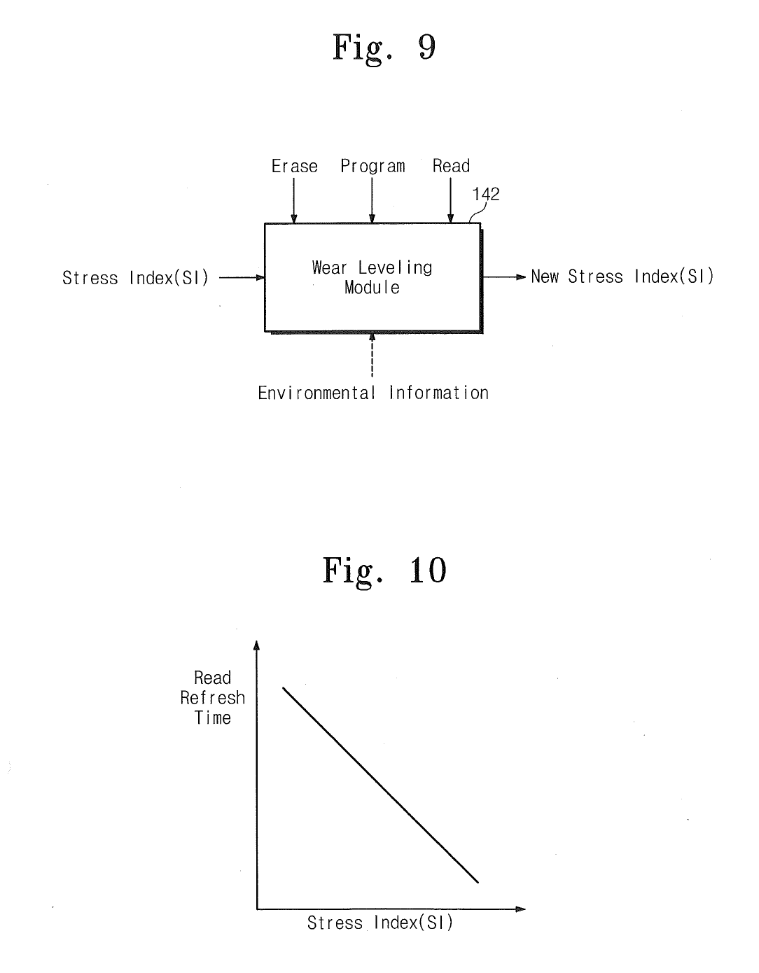

FIG. 9 is a block diagram illustrating stress index increase methods of the wear leveling module 142 in FIG. 1 according to other example embodiments of the inventive concepts. Referring to FIG. 9, a wear leveling method 142 may increase a stress index according to an erasing operation, a programming operation and/or a reading operation. The wear leveling module 142 may change a stress index in proportion to a degree of threshold voltage change of a specific memory cell in the physical block PBi. Physical conditions (e.g., noise and/or temperature) may be considered.

FIG. 10 is a graph of read refresh time as a function of stress index according to example embodiments of the inventive concepts. The read refresh time may denote a time when stored data is refreshed upon a writing request. Referring to FIG. 10, as a stress index increases the read refresh time may be reduced. As the stress index increases wear leveling may be required to vary upon a writing request. According to example embodiments of the inventive concepts, the block information table (see FIG. 1) may store a time when data is written in a physical block. By comparing a time when data is written and a time when a current reading operation is performed, the wear leveling module 142 (see FIG. 1) may determine whether a read refresh time arrives. According to example embodiments of the inventive concepts, the block information table may store P/E cycle information. The wear leveling module 142 may determine whether the read refresh time arrives on the basis of the P/E cycle information.

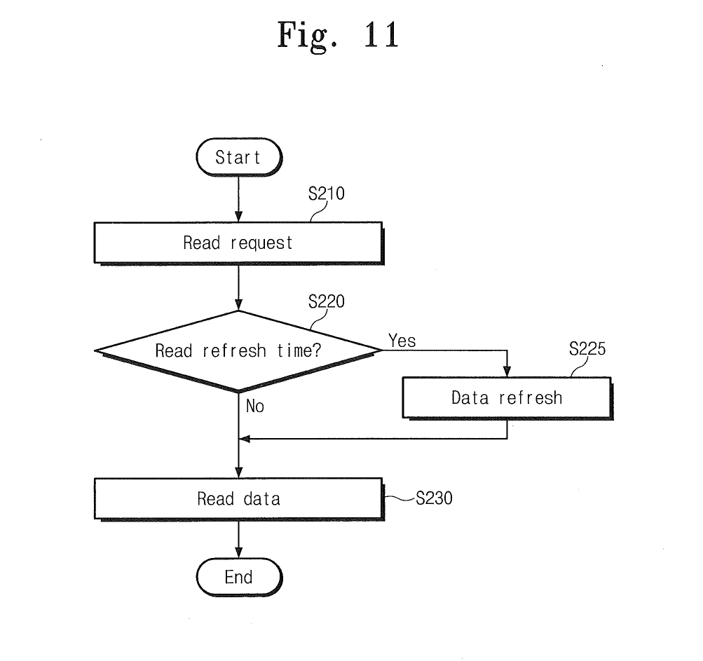

FIG. 11 is a flowchart illustrating wear leveling methods of the memory system upon a writing request. Referring to FIGS. 1-11, upon a write request, the host may request a read to the memory system 100. The memory controller 140 (see FIG. 1) may receive a read command and a logical address according to a writing request in operation S210. The memory controller 140 may determine whether a physical block corresponding to an input logical address exceeds a read refresh time in operation S220. The read refresh time may be different according to the stress index of the physical block PBi. When the read refresh time is not exceeded, operation S230 may be performed. When the read refresh time is exceeded, a data refresh operation may be performed by copying the data of a physical block in a new physical block in operation S225.

Wear leveling may be performed between a physical block and a new physical block. Data may be read from a physical block corresponding to an input logical address or a data-refreshed physical block in operation S230. According to example embodiments of the inventive concepts, when a wear leveling condition is satisfied upon a writing request and a read refresh time is exceeded, a data-stored physical block is exchanged with a new physical block.

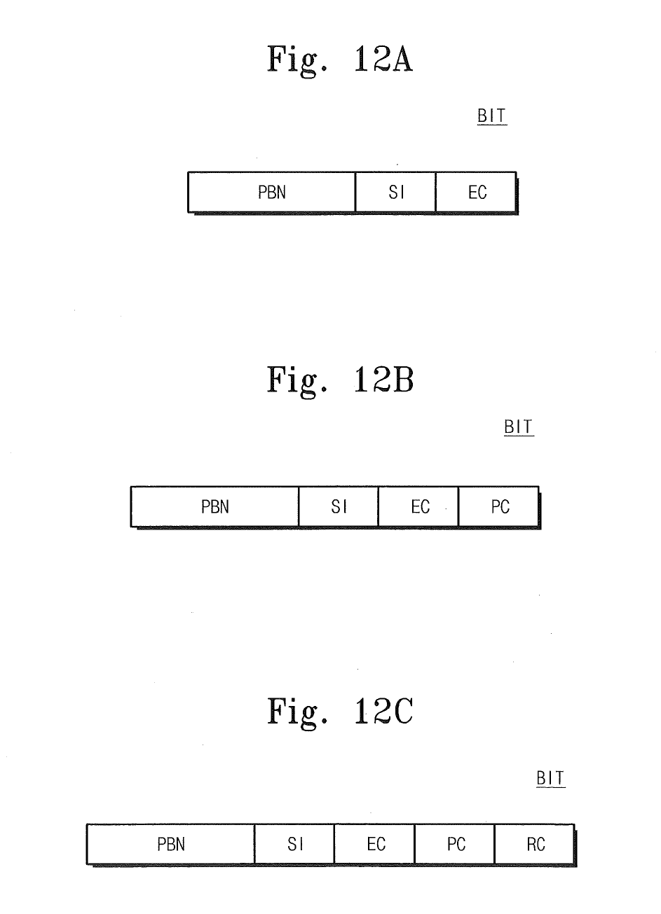

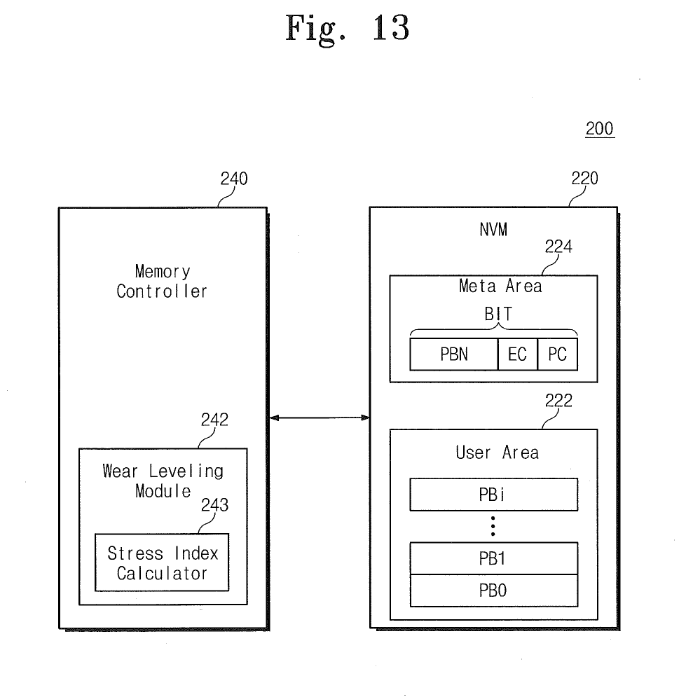

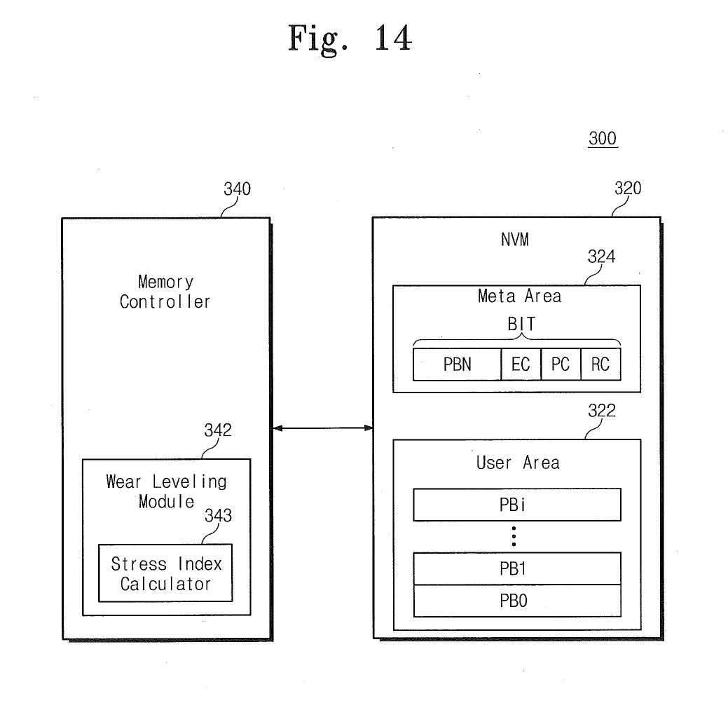

FIGS. 12A-12C are block diagrams illustrating block information tables according to example embodiments of the inventive concepts. Referring to FIGS. 12A-12C, a block information table may include information on an operation count. Referring to FIG. 12A, a block information table BIT may store a physical block number PBN indicating a physical block, a stress index SI of a physical block and erasure count EC. Referring to FIG. 12B, a block information table BIT may store a physical block number PBN indicating a physical block, a stress index SI of a physical block, erasure count EC and programming count PC. Referring to FIG. 12C, a block information table BIT may store a physical block number PBN indicating a physical block, a stress index SI of a physical block, erasure count EC, programming count PC and read count RC.

In FIGS. 1-12, wear leveling may be performed using a stress index based on point values assigned to particular types of operations that is stored in a block information table BIT. Wear leveling according to example embodiments of the inventive concepts is not limited thereto. According to example embodiments of the inventive concepts, wear leveling may be performed according to a stress index that is calculated on the basis of count information. The count information may indicate an erasure count, a programming count and/or a read count.

FIG. 13 is a block diagram illustrating memory systems according to other example embodiments of the inventive concepts. Referring to FIG. 13, a memory system 200 according to other example embodiments of the inventive concepts may include a nonvolatile memory device 220 and a memory controller 240. A user area 222 may store user data. The user area 222 may include a plurality of physical blocks PB0-PBi, where may be a natural number. A meta area 224 may include a block information table BIT used to perform wear leveling. The block information table may include a physical block number PBN indicating a physical block, an erasure count EC where the physical block has undergone erasure, and programming count PC where the physical block has undergone programming.

A wear leveling module 242 may include a stress index calculator 243 that calculates a stress index of a physical block on the basis of the count information of block information table of the meta area 224. According to other example embodiments of the inventive concepts, the stress index calculator 243 may vary a stress index on the basis of environmental information (e.g., temperature and noise) of the memory system 200. The memory system 200 may calculate a stress index according to erasure count and programming count, and may perform wear leveling with the calculated stress index.

FIG. 14 is a block diagram illustrating memory systems according to still other example embodiments of the inventive concepts. Referring to FIG. 14, a memory system 300 according to example embodiments of the inventive concepts may include a nonvolatile memory device 320 and a memory controller 340. The nonvolatile memory device 320 may include meta area 324 including a block information table BIT that includes a physical block number PBN indicating a physical block, erasure count EC where the physical block has undergone, programming count PC where the physical block has undergone programming, and/or read count RC where the physical block has undergone a read. A user area 322 may store user data. The user area 322 may include a plurality of physical blocks PB0-PBi, where may be a natural number.

The memory controller 340 may include a wear leveling module 242 including a stress index calculator 343 that calculates a stress index according to the erasure count EC, the programming count PC or the read count RC. The memory system 300 may calculate a stress index according to erasure count, programming count and read count, and perform wear leveling with the calculated stress index.

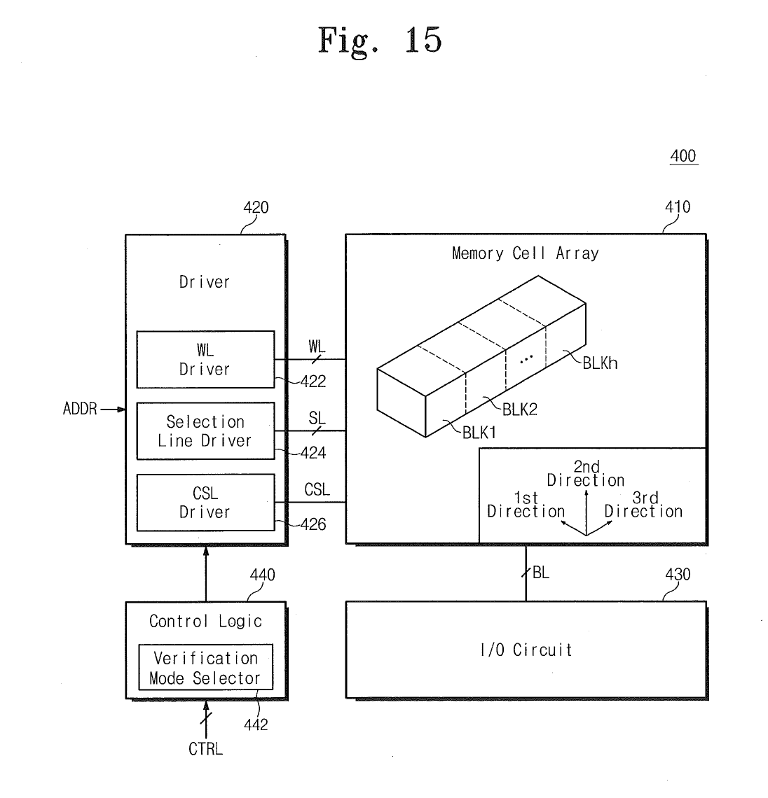

FIG. 15 is a block diagram illustrating vertical NAND flash memory devices according to example embodiments of the inventive concepts. Referring to FIG. 15, a nonvolatile memory device 400 may include a memory cell array 410, a driver 420, an input/output (I/O) circuit 430 and control logic 440. The memory cell array 410 may include a plurality of memory blocks BLK1-BLKh where h is a natural number. Each of the memory blocks BLK1-BLIKh may include a plurality of memory cells. Each of the memory blocks BLK1-BLKh may have a vertical structure (e.g., a three-dimensional (3D) structure). According to example embodiments of the inventive concepts, each of the memory blocks BLK1-BLIKh may include structures that extend in first to third directions.

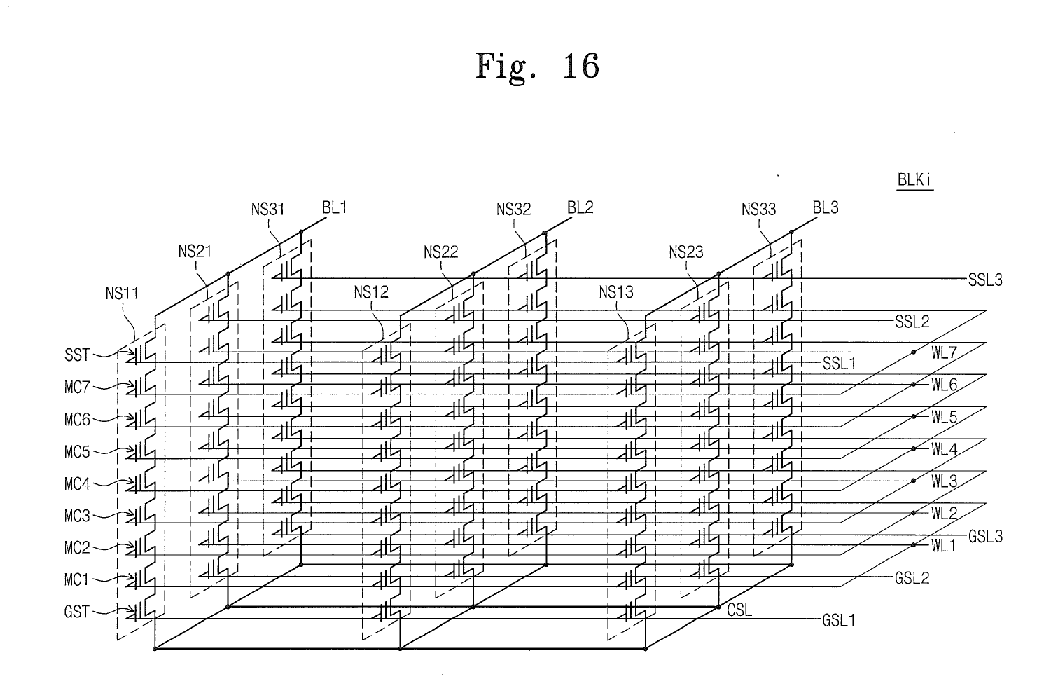

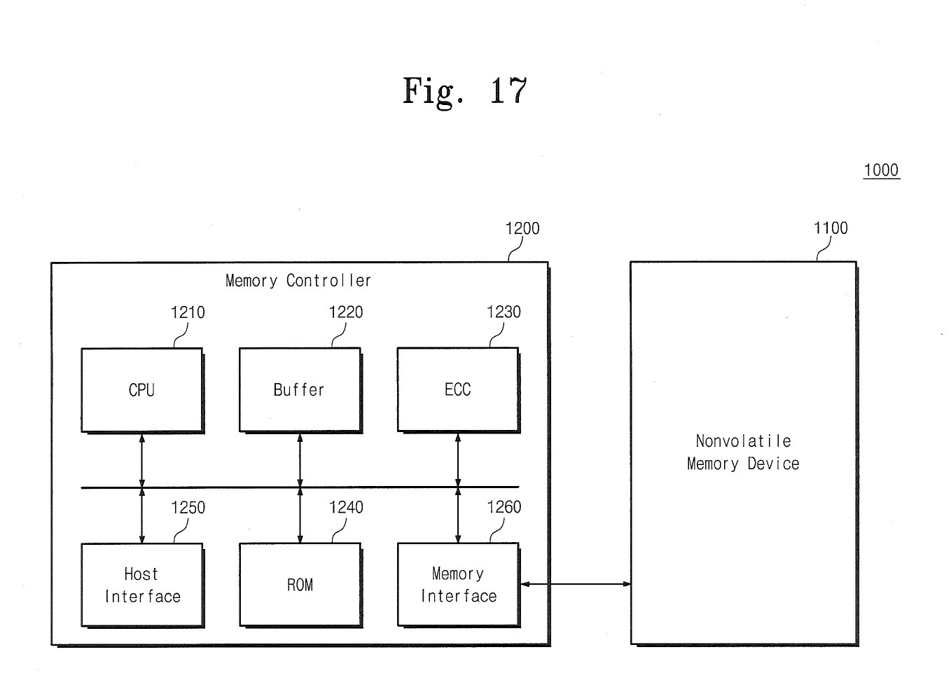

Each of the memory blocks BLK1-BLKh may include a plurality of NAND strings NS (see FIG. 16) extending in the second direction. Each of the memory blocks BLK1-BLKh may include a plurality of NAND strings NS extending in the first and third directions. Each of the NAND strings NS may be connected to a bit line BL, at least one string selection line SSL, at least one ground selection line GSL, word lines WL and a common source line CSL. Each of the memory blocks BLK1-BLKh may be connected to a plurality of bit lines BL, a plurality of string selection lines SSL (see FIG. 16), a plurality of ground selection lines GSL (see FIG. 16), a plurality of word lines WL and a plurality of common source lines CSL.

The driver 420 may be connected to the memory cell array 410 through a plurality of word lines WL. The driver 420 may operate according to the control of the control logic 440. The driver 420 may receive an address ADDR from the outside. The driver 420 may decode the input address ADDR. The driver 420 may select one from among the plurality of word lines WL by using the decoded address. The driver 420 may apply a voltage to selected and unselected word lines.

According to example embodiments of the inventive concepts, in a programming operation, a reading operation and/or an erasing operation, the driver 420 may apply a program voltage associated with the programming operation, a read voltage associated with the reading operation and/or an erasure voltage associated with the erasing operation to word lines WL. According to example embodiments of the inventive concepts, the driver 420 may include a word line driver 422 that selects and drives word lines. The driver 420 may select and drive a plurality of selection lines SL. According to example embodiments of the inventive concepts, the driver 420 may select and drive a string selection line SSL and a ground selection line GSL. According to example embodiments of the inventive concepts, the driver may include a selection line driver 424 for selecting and driving selection lines.

The driver 420 may drive a common source line CSL. According to example embodiments of the inventive concepts, the driver 420 may includes a common source line driver 426 for driving the common source line CSL. The input/output circuit 430 may be connected to the memory cell array 410 through a plurality of bit lines BL. The input/output circuit 430 may operate according to the control of the control logic 440. The input/output circuit 430 may select the bit lines BL. According to example embodiments of the inventive concepts, the input/output circuit 430 may receive data (not shown) from the outside and store the input data DATA in the memory cell array 410. The input/output circuit 430 may read the data from the memory cell array 410 and transfer the read data to the outside.

The input/output circuit 430 may read data from a first storage area of the memory cell array 410 and store the read data in a second storage area of the memory cell array 410. According to example embodiments of the inventive concepts, the input/output circuit 430 may perform a copy-back operation. According to example embodiments of the inventive concepts, the input/output circuit 430 may include elements such as a page buffer (or a page register), a column selection circuit and/or a data buffer. According to example embodiments of the inventive concepts, the input/output circuit 430 may include elements, for example, a sensing amplifier, a writing driver, a column selection circuit and/or a data buffer. The control logic 440 may control the overall operation of the nonvolatile memory device 400. The control logic 440 may operate in response to control signals CTRL that are transferred from the outside. The control logic 440 may include a verification mode selector 442.

FIG. 16 is a circuit diagram illustrating an equivalent circuit of one of the memory blocks BLKi in FIG. 15. Referring to FIGS. 15 and 16, NAND strings NS11-NS31 may be between a first bit line BL1 and a common source line CSL. The first bit line BL1 may correspond to a conductive material that is extended in the third direction. NAND strings NS 12, NS 22 and NS32 may be between the second bit line BL2 and the common source line CSL. The second bit line BL2 may correspond to a conductive material that is extended in the third direction. NAND strings NS13, NS 23 and NS33 may be between the third bit line BL3 and the common source line CSL. The third bit line BL3 may correspond to a conductive material that is extended in the third direction.

The string selection transistor SST of each NAND string NS may be connected to a corresponding bit line BL. The ground selection transistor GST of each NAND string NS may be connected to the common source line CSL. Memory cells MC (e.g., MC1-MC7) may be between the string selection transistor SST and ground selection transistor GST of each NAND string NS. Hereinafter, NAND strings NS may be defined by row and column units. NAND strings NS that are connected to one bit line in common may be part of one column. According to example embodiments of the inventive concepts, NAND strings NS11-NS31 connected to the first bit line BL1 may correspond to a first column. NAND strings NS12-NS2 connected to the second bit line BL2 may correspond to a second column. NAND strings NS13-NS33 connected to the third bit line BL3 may correspond to a third column.

NAND strings NS connected to one string selection line SSL may be part of one row. According to example embodiments of the inventive concepts, NAND strings NS11-NS3 connected to the first string selection line SSL1 may correspond to a first row. NAND strings NS21-NS23 connected to the second string selection line SSL2 may correspond to a second row. NAND strings NS31-NS33 connected to the third string selection line SSL3 may correspond to a third row. In each NAND string NS, a height may be defined. According to example embodiments of the inventive concepts, in each NAND string NS, the height of a memory cell MC1 adjacent to the ground selection transistor GST may be 1. In NAND string NS, the height of a memory cell increases as a function of distance from a ground selection transistor GST. In each NAND string NS, the height of a memory cell MC7 adjacent to the string selection transistor SST may be 7.

The NAND strings NS of a same row may share a string selection line SST. The NAND strings NS of different rows may be connected to different string selection lines SSL. Memory cells with the same height in the NAND strings NS of the same row may share a word line (e.g., one of WL1-WL7). At the same height, the word lines WL of NAND strings NS of different rows may be connected in common. According to example embodiments of the inventive concepts, word lines WL may be connected in common in a layer to which conductive materials extend in the first direction are applied. Conductive materials extended in the first direction may be connected to an upper layer through a contact. In the upper layer, conductive materials extended in the first direction may be connected in common. The NAND strings NS of a same row may share a ground selection line GSL (e.g., one of GSL1-GSL3). The NAND strings NS of different rows may be connected to different ground selection lines GSL.

The common source line CSL may be connected to the NAND strings NS in common. According to example embodiments of the inventive concepts, first to fourth doping regions may be connected to an upper layer through a contact. In the upper layer, the first to fourth doping regions may be connected in common. As illustrated in FIG. 16, the word lines WL having the same height may be connected in common. When a specific word line WL is selected, all NAND strings NS connected to the specific word line WL may be selected. By selecting string selection lines SSL1-SSL3, the NAND strings NS of an unselected row among NAND strings NS connected to the same word line WL may be separated from bit lines BL1-BL3. By selecting string selection lines SSL1-SSL3, a row of NAND strings NS may be selected. By selecting the bit lines BL1-BL3, the NAND strings NS of a selected row may be selected by column units.

FIG. 17 is a block diagram illustrating memory systems according to example embodiments of the inventive concepts. Referring to FIG. 17, a memory system 1000 according to example embodiments of the inventive concepts may include a nonvolatile memory device 1100 and a memory controller 1200. The nonvolatile memory device 1100 may store a block information table that includes a physical block number and a stress index thereof. The nonvolatile memory device 1100 may include, for example, at least one of the nonvolatile memory devices described above with respect to FIGS. 1-16. The memory controller 1200 may control the nonvolatile memory device 1100 according to a request from the outside (e.g., a host). For example, the memory controller 1200 may control reading, writing and/or erasing operations of the nonvolatile memory device 1100. The memory controller 1200 may perform wear leveling on the basis of a stress index. The memory controller 1200 may be one of the memory controllers described above with respect to FIGS. 1-16.

The memory controller 1200 may provide an interface between the nonvolatile memory device 1100 and a host (not shown). The memory controller 1200 may drive a firmware for controlling the nonvolatile memory device 1100. The firmware may increase a stress index according to an erasing/programming/reading operation and may include a wear leveling module that performs wear leveling on the basis of the stress index, The memory controller 1200 may includes a Central Processing Unit (CPU) 1210, a buffer 1220, an Error Correction Circuit (ECC) 1230, a ROM 1240, a host interface 1250 and a memory interface 1260. The CPU 1210 may control the overall operation of the memory controller 1200. The buffer 1220 may be used as the working memory of the CPU 1210. When the host requests writing, data input from the host may be temporarily stored in the buffer 1220. When the host requests a read, data read from the nonvolatile memory device 1100 may be temporarily stored in the buffer 1220. The error correction circuit 1230 may decode data, which may be stored in the buffer 1220, with an error correction code upon a writing request.

The decoded data and the error correction code value may be stored in the nonvolatile memory device 1100. The error correction circuit 1230 may restore data, which is read from the nonvolatile memory device 1200, with the error correction code value upon a read request. The error correction code value may be included in the read data. The ROM 1240 may store data necessary for driving the memory controller 1200, The host interface 1250 may include a protocol for performing data exchange between the host and the memory controller 1200. For example, the memory controller 1200 may communicate with the outside through one of various interface protocols, for example, a Universal Serial Bus (USB) protocol, a Multimedia Card (MMC) protocol, a Peripheral Component Interconnection (PCI) protocol, a PCI-Express (PCI-E) protocol, an Advanced Technology Attachment (ATA) protocol, a Serial-ATA (SATA) protocol, a Parallel-ATA (PATA) protocol, a Small Component Small Interface (SCSI) protocol, an Enhanced Small Disk Interface (ESDI) protocol and/or a Integrated Drive Electronics (IDE) protocol.

The memory interface 1260 may be an interface between the nonvolatile memory device 1100 and the memory controller 1200. The memory system 1000 may increase a stress index according to one or more operations that a physical block has undergone, and by performing wear leveling on the basis of the stress index, the memory system 1000 may enhance the reliability of data and the service life of data. The memory system 1000 may wear level even without information on erasure count.

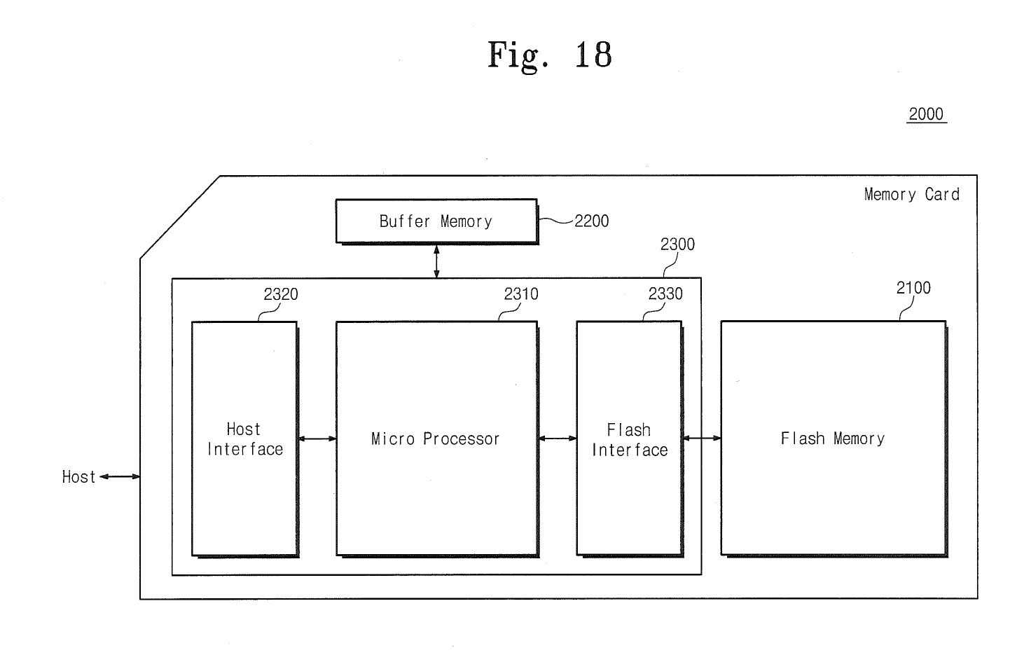

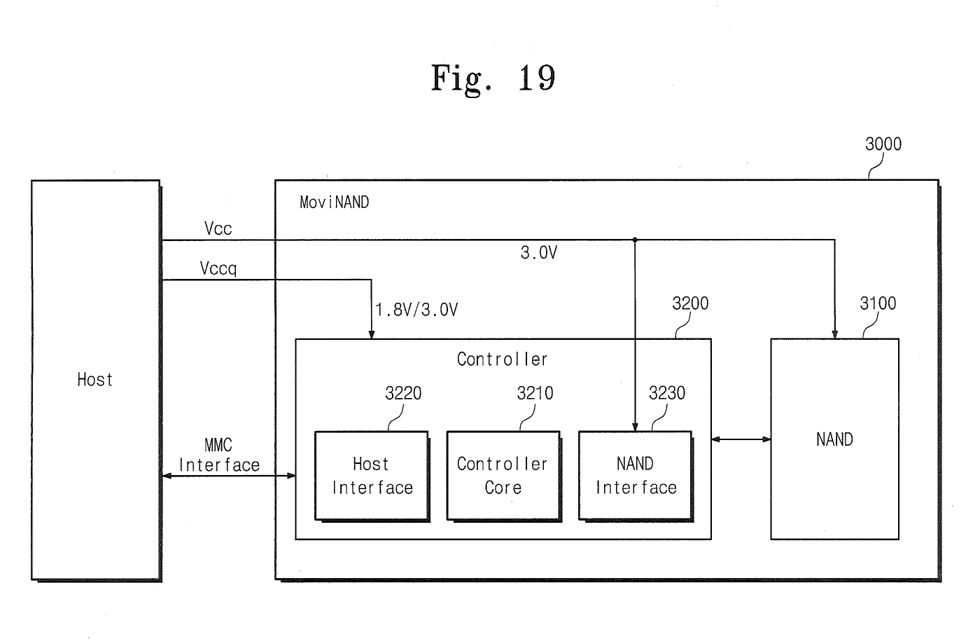

FIG. 18 is a block diagram illustrating memory cards according to example embodiments of the inventive concepts. Referring to FIG. 18, a memory card 2000 according to example embodiments of the inventive concepts may include a flash memory device 2100, a buffer memory device 2200 and a memory controller 2300 to control the devices 2100 and 2200. The flash memory device 2100 may store a block information table that includes a physical block number and a stress index thereof. The flash memory device 2100 may include at least one of the nonvolatile memory devices described above with respect to FIGS. 1-16. The buffer memory device 2200 may be a device for temporarily storing data that is generated while the memory card 2000 is being driven. The buffer memory device 2200 may be implemented with a DRAM or an SRAM. The memory controller 2300 may be connected between the host and the flash memory device 2100. In response to a request from the host, the memory controller 2300 may access the flash memory device 2100.

The memory controller 2300 may perform wear leveling on the basis of a stress index. The memory controller 2300 may be one of the memory controllers described above with respect to FIGS. 1-16. The memory controller 2300 may includes a microprocessor 2310, a host interface 2320 and a flash interface 2330. The microprocessor 2310 may drive firmware. The firmware may include a wear leveling module that performs wear leveling on the basis of a stress index. The host interface 2320 may interface with the host through a card (e.g., MMC) protocol for performing data exchange between the host and the flash interface 2330. The memory card 2000 may be applied to Multi Media Cards (MMCs), Security Digital (SD) cards, miniSD cards, memory stick cards, SmartMedia cards and TransFlash cards. The memory card 2000 may perform wear leveling with a stress index and thus may enhance the reliability of stored data.

FIG. 19 is a block diagram illustrating a moviNAND according to example embodiments of the inventive concepts. Referring to FIG. 19, a moviNAND 3000 according to example embodiments of the inventive concepts may include a NAND flash memory device 3100 and a controller 3200. The NAND flash memory device 3100 may be implemented by stacking single-item NAND flash memory devices on one package (e.g., Fine-pitch Ball Grid Array (FBGA)). Each of the single-item NAND flash memory devices may store a block information table that includes a physical block number and a stress index thereof. The flash memory device 2100 may include at least one memory device described above with respect to FIGS. 1-16. The controller 3200 may include a controller core 3210, a host interface 3220, and a NAND interface 3230. The controller core 3210 may control the overall operation of the moviNAND 3000.

The controller core 3210 may perform wear leveling on the basis of a stress index. The memory controller 3210 may be a memory controller described above with respect to FIGS. 1-16. The host interface 3220 may perform MMC interfacing between the host and the controller 3210. The NAND interface 3230 may be an interface between the NAND flash memory device 3100 and the controller 3200. The moviNAND 3000 may receive power source voltages Vcc and Vccq from the host. A power source voltage Vcc of 3 V may be supplied to the NAND flash memory device 3100 and the NAND interface 3230, and a power source voltage Vccq of 1.8V/3V may be supplied to the controller 3200. The moviNAND 3000 may perform wear leveling on the basis of the stress index upon a write request and/or a read request, thereby improving the service life of data.

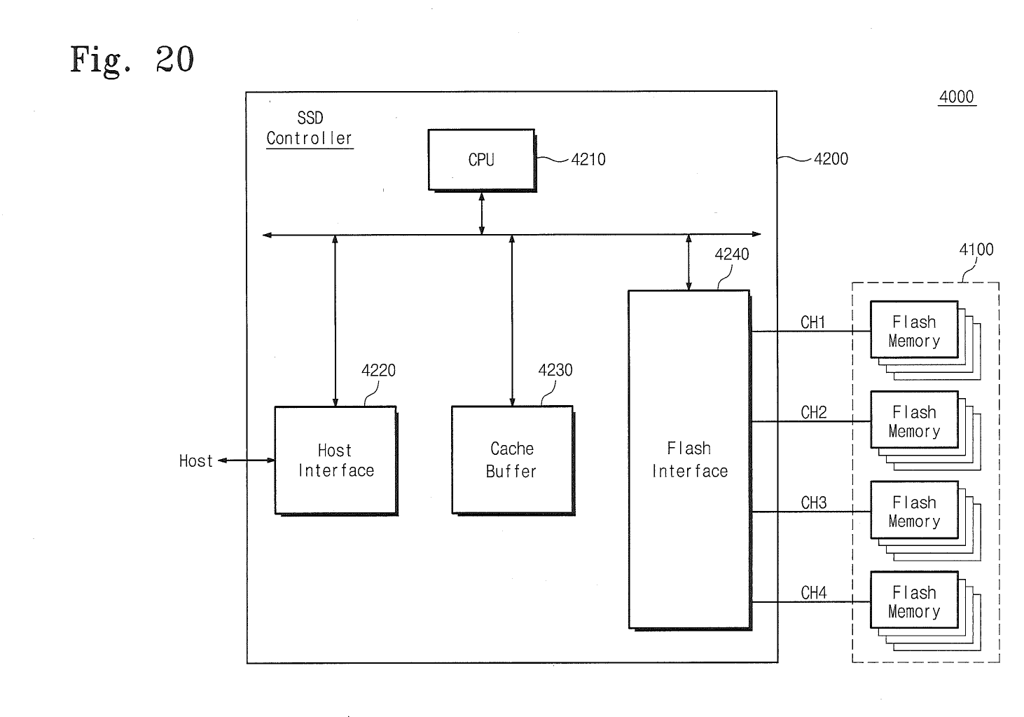

FIG. 20 is a block diagram illustrating Solid State Drives (SSDs) according to example embodiments of the inventive concepts. Referring to FIG. 20, an SSD 4000 according to example embodiments of the inventive concepts may include a plurality of flash memory devices 4100 and an SSD controller 4200. Each of the flash memory devices 4100 may store a block information table that includes a physical block number and a stress index thereof. The flash memory device 4100 may include at least one of the nonvolatile memory devices described above with respect to FIGS. 1-16. The SSD controller 4200 may control the flash memory devices 4100. The SSD controller 4200 may perform wear leveling on the basis of a stress index. The SSD controller 4200 may be one of the memory controllers described above with respect to FIGS. 1-16.

The SSD controller 4200 may include a CPU 4210, a host interface 4220, a cache buffer 4230 and a flash interface 4240. The host interface 4220 may exchange data with a host through an Advanced Technology Attachment (ATA) protocol according to the control of the CPU 4210. The host interface 4220 may be a Serial-ATA (SATA) interface, a Parallel-ATA (PATA) interface and/or an External SATA (ESATA) interface. Data input from the host through the host interface 4220 and/or data to be transmitted to the host may be transferred to the cache buffer 4230 without passing through a CPU bus according to the control of the CPU 4210.

The cache buffer 4230 may temporarily store mobile data between the outside and the flash memory devices 4100. The cache buffer 4230 may be used to store a program to be operated by the CPU 4210. The cache buffer 4230 may be regarded as a kind of buffer memory and may be implemented with an SRAM. The flash interface 4240 may be an interface between the SSD controller 4200 and the flash memory devices 4100 used as a storage device. The flash interface 4240 may support a NAND flash memory, a One-NAND flash memory, a multi-level flash memory and a single level flash memory. The SSD 400 may perform wear leveling on the basis of the stress index, thereby improving the service life of data.

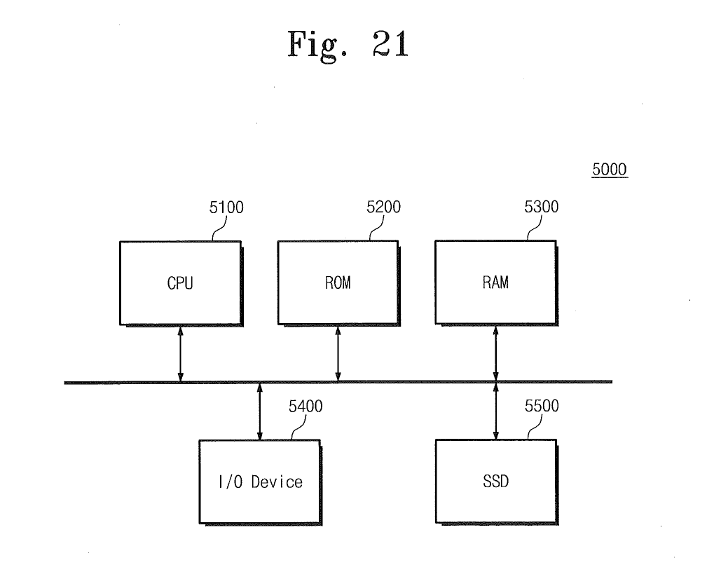

FIG. 21 is a block diagram illustrating computing systems including SSDs of FIG. 20 according to example embodiments of the inventive concepts. Referring to FIG. 21, a computing system 5000 according to example embodiments of the inventive concepts may include a CPU 5100, a ROM 5200, a RAM 5300, an input/output (I/O) device 5400 and an SSD 5500. The CPU 5100 may be connected to a system bus. The ROM 5200 may store data necessary for driving the computing system 5000. Necessary data may include an initial command sequence and/or a basic input/output operation system (e.g., BIOS) sequence. The RAM 5300 may temporarily store data that is generated when the CPU 5100 is executed. According to example embodiments of the inventive concepts, as the input/output device 5400, there may be a keyboard, a pointing device (e.g., a mouse), a monitor and/or a modem. Such input/output devices may be connected to the system bus through an input/output device interface. As a readable storage device, the SSD 5500 may be an SSD 4000 of FIG. 20.

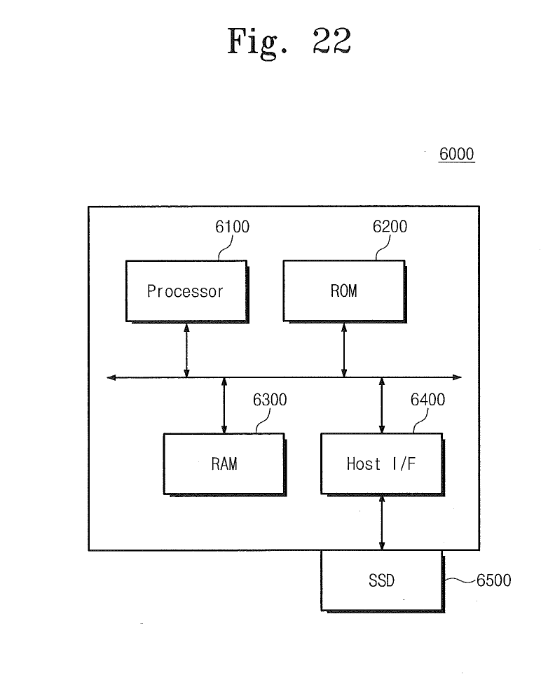

FIG. 22 is a block diagram illustrating electronic devices including SSDs of FIG. 20 according to example embodiments of the inventive concepts. Referring to FIG. 22, an electronic device 6000 according to example embodiments of the inventive concepts may include a processor 6100, a ROM 6200, a RAM 6300, a host interface 6400, and an SSD 6500. The processor 6100 may access the RAM 6300 to execute firmware and/or arbitrary code. The processor 6100 may access the ROM 6200 to execute fixed command sequences, for example, an initial command sequence and/or basic input/output operation system sequences. The host interface 6400 may be an interface between the electronic device 6000 and the SSD 6500. The SSD 6500 may be attached to and/or detached from the electronic device 6000. The SSD 6500 may be an SSD 4000 of FIG. 20. An electronic device 6000 according to example embodiments of the inventive concepts may be a cellular phone, a Personal Digital Assistant (PDA), a digital camera, a camcorder, a portable audio replay device (for example, MP3), and a Portable Multimedia Player (PMP).

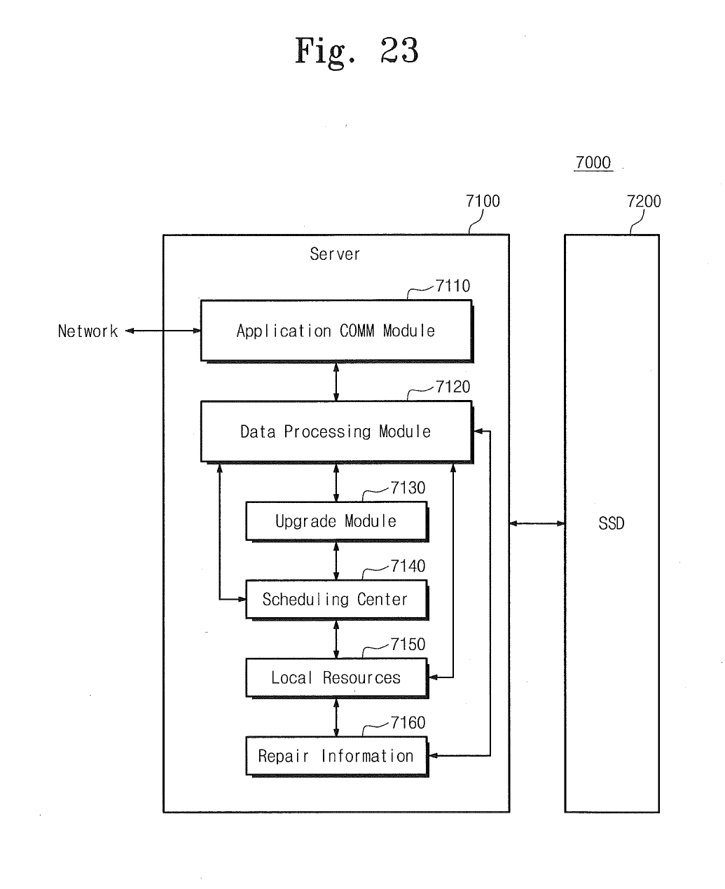

FIG. 23 is a block diagram illustrating server systems using SSDs of FIG. 20, according to example embodiments of the inventive concepts, Referring to FIG. 23, a server system 7000 according to example embodiments of the inventive concepts may include a server 7100 and an SSD 7200 storing data necessary for driving the server 7100, The SSD 7200 may have the same configuration and operation of an SSD 4000 of FIG. 20. The server 7100 may include an application communication module 7110, a data processing module 7120, an upgrade module 7130, a scheduling center 7140, a local resource module 7150 and a repair information module 7160. The application communication module 7110 may communicate with a computing system that is connected to the server 7100 over a network, or allow the sever 7100 to communicate with the SSD 7200. The application communication module 7110 may transmit data and/or information through a user interface to the data processing module 7120.

The data processing module 7120 may be linked to the local resource module 7150. The local resource module 7150 may supply a list of repair shops/dealers/technical information to a user on the basis of input data and/or information. The upgrade module 7130 may interface with the data processing module 7120. The upgrade module 7130 may upgrade a firmware, a reset code, diagnosis system upgrade and/or other information in an appliance, on the basis of data and/or information that is transmitted from the SSD 7200. The scheduling center 7140 may allow a real-time option to the user on the basis of data and/or information that is input to the server 7100.

The repair information module 7160 may interface with the data processing module 7120. The repair information module 7160 may be used to apply repair-related information (e.g., audio, video and/or a document file) to the user. The data processing module 7120 may package relevant information on the basis of information transferred from the SSD 7200. Such information may be transmitted to the SSD 7200 and/or may be displayed to the user. Heating may be severe in a server. Due to heating, there is a possibility that reliability of a memory cell may decrease in a programming operation. The server system 7000 according to example embodiments of the inventive concepts may include an SSD 7200 that uses an optimal and/or improved verification mode according to temperature upon a programming operation, thereby improving reliability of data.

The memory system and/or the storage device according to example embodiments of the inventive concept may be mounted with various types of packages. For example, the memory system and/or the storage device according to example embodiments of the inventive concepts may be mounted with Package on Package (PoP), Ball Grid Arrays (BGAs), Chip Scale Packages (CSPs), Plastic Leaded Chip Carrier (PLCC), Plastic Dual In-Line Package (PDIP), Die In Waffle Pack (DIWP), Die In Wafer Form (DIWF), Chip On Board (COB), Ceramic Dual In-Line Package (CERDIP), Plastic Metric Quad Flat Pack (MQFP), Thin Quad Flat Pack (TQFP), Small Outline Package (SOP), Shrink Small Outline Package (SSOP), Thin Small Outline Package (TSOP), Thin Quad Flat Pack (TQFP), System In Package (SIP), Multi Chip Package (MCP), Wafer Level Stack Package (WLSP), Die In Wafer Form (DIWF), Die On Waffle Package (DOWP), Wafer-level Fabricated Package (WFP) and/or Wafer-Level Processed Stack Package (WSP).

According to example embodiments of the inventive concepts, a memory system and a wear leveling method thereof may increase the stress index in proportion to operations that the physical block has undergone and perform wear leveling on the basis of the stress index, thereby performing more accurate and/or improved wear leveling.

While example embodiments have been particularly shown and described, it will be understood by one of ordinary skill in the art that variations in form and detail may be made therein without departing from the spirit and scope of the claims.

What is claimed is:

1. A memory system wear leveling method, comprising:
increasing a stress index of one of a plurality of physical blocks in a memory system according to at least one operation performed on the physical block; and
wear leveling the memory system based on the stress index.

2. The wear leveling method of claim 1, wherein the increasing of the stress index includes increasing the stress index upon performing one of an erase operation and a program operation on the physical block.

3. The wear leveling method of claim 2, wherein the increasing of the stress index includes increasing the stress index upon performing a read operation on the physical block.

4. The wear leveling method of claim 2, wherein the increasing of the stress index includes varying the stress index according to at least one of temperature and noise of the memory system.

5. The wear leveling method of claim 2, wherein the increasing of the stress index includes increasing the stress index a same amount upon each performance of one of a plurality of erase operations and a plurality of program operations.

6. The wear leveling method of claim 3, wherein the increasing of the stress index includes increasing the stress index by 25 upon performing the erase operation and increasing the stress index by 1.17 upon performing the program operation.

7. The wear leveling method of claim 2, wherein the increasing of the stress index includes increasing the stress index a different amount upon performance of the erase operation than upon performance of the program operation.

8. The wear leveling method of claim 1, further comprising:
storing a block information table including identification information of the physical block and the stress index of the physical block in a nonvolatile memory device.

9. The wear leveling method of claim 1, wherein wear leveling includes copying data stored in a physical block with a maximum stress index into a physical block with a minimum stress index upon determining a difference between the maximum stress index and the minimum stress index exceeds a threshold value.

10. The wear leveling method of claim 1, wherein the wear leveling includes
receiving a write request in the memory system,
determining that a free page does no exist;
erasing a data block,
identifying a first physical block with a maximum stress index and a second physical block with a minimum stress index,
determining that the difference between the maximum stress index and the minimum stress index is greater than a threshold value,
copying data of the first physical block into the erased data block,
erasing the first physical block,
copying data of the second physical block into the first physical block,
erasing the second physical block, and
writing data into the second physical block.

11. The wear leveling method of claim 2, wherein the wear leveling includes
receiving a write request in the memory system,
determining that a free page does not exist;
identifying a first physical block with a maximum stress index and a second physical block with a minimum stress index,
determining a difference between the maximum stress index and the minimum stress index does not exceed a threshold value,
erasing a data block, and
writing write request data into the erased data block.

12. The wear leveling method of claim 1, wherein the wear leveling includes
receiving a read request in the memory system, and
copying data of a first physical block exceeding a read refresh time, the read refresh time corresponding to a first stress index, into a second physical block with a second stress index that is a minimum stress index.

13. The wear leveling method of claim 12, wherein the read refresh time is inversely proportional to the first stress index.

14. A memory system, comprising:
a nonvolatile memory device configured to store a block information table including a number representing a physical block and a stress index representing a wear level of the physical block; and
a memory controller configured to control the nonvolatile memory device, and to perform wear leveling based on the block information table.

15. The memory system of claim 14, wherein the block information table further includes an erasure count of the physical block.

16. The memory system of claim 15, wherein the block information table further includes a programming count of the physical block.

17. The memory system of claim 15, wherein the block information table further includes a read count of the physical block.

18. The memory system of claim 14, wherein the nonvolatile memory device includes a vertical memory cell array.

19. A memory system, comprising:
a nonvolatile memory device configured to store a block information table including a number representing a physical block, an erasure count of the physical block and a programming count of the physical block; and
a memory controller configured to control the nonvolatile memory device, to calculate a stress index of the physical block based on the erasure count and the programming count, and to perform wear leveling on the basis of the calculated stress index.

20. A memory system, comprising:
a nonvolatile memory device configured to store a block information table including an erasure count of a physical block, a programming count of the physical block, a read count of the physical block and a number representing the physical block; and
a memory controller configured to control the nonvolatile memory device, to calculate a stress index of the physical block based on the erasure count, the programming count and the read count, and to perform wear leveling based on the calculated stress index.

21. A method of wear leveling a semiconductor device, comprising:
determining a usage level of each of a plurality of cells in a semiconductor device based on at least one operation of the plurality of cells;
storing data corresponding to the usage levels; and
using the plurality of cells based on the usage levels.

22. The method of claim 21, wherein the at least one operation is a plurality of different operations,
each of the plurality of different operations is assigned a different usage value; and
the storing of the data corresponding to the usage levels includes storing a plurality of sums of the different usage values.

23. The method of claim 22, wherein the using of the plurality of cells based on the usage levels includes reducing a frequency of use of at least one of the plurality of cells corresponding to a greatest sum of the plurality of sums.

24. The method of claim 22, wherein the using of the plurality of cells includes assigning high frequency operations of at least one first cell of the plurality of cells with a relatively high usage level to at least one second cell of the plurality of cells.

25. The method of claim 24, wherein the different operations are different logical operations.

26. The method of claim 24, wherein the different operations correspond to different combinations of voltages applied to the plurality of cells.

27. The method of claim 24, wherein the plurality of cells are a plurality of memory units, and
the using of the plurality of cells based on the usage levels includes moving frequently accessed data from a first memory unit with a relatively high usage level to a second memory unit with a lower usage level than the first memory unit.

28. The method of claim 27, wherein the plurality of memory units are one of a plurality of memory cells, a plurality of pages of memory cells and a plurality of memory arrays.

29. The method of claim 27, wherein the plurality of different operations include program and erase operations.

30. The method of claim 28, wherein the using of the plurality of cells based on the usage levels includes identifying a first cell with a greatest usage level and a second cell with a lowest usage level, and swapping stored data between the first and second cells upon determining that a difference between a sum of the plurality of sums corresponding the first cell and a sum of the plurality of sums corresponding to the second cell is greater than a threshold value.

31. The method of claim 28, wherein the using of the plurality of cells includes identifying a first cell with a greatest usage level and a second cell with a lowest usage level, and moving stored data of the first cell to a different cell, upon determining that a difference between a sum of the plurality of sums corresponding the first cell and a sum of the plurality of sums corresponding to the second cell is greater than a threshold value.

32. The method of claim 31, wherein an erase operation is assigned a usage value about 15 times greater than a program operation.
